(19) United States
(12) Patent Application Publication
(10) Pub. No.: US 2011/0197699 A1
(43) Pub. Date: Aug. 18, 2011

(54) STEERING SYSTEM FOR FORKLIFT

(75) Inventor: Eui Dong Lee, Seoul (KR)

(73) Assignee: DOOSAN INFRACORE CO., LTD., Incheon (KR)

(21) Appl. No.: 13/125,265

(22) PCT Filed: Oct. 21, 2009
(86) PCT No.: PCT/KR09/06069

§ 371 Date: Apr. 20, 2011

(30) Foreign Application Priority Data
Oct. 23, 2008 (KR) 10-2008-0104219

(51) Int. Cl. G05G 1/04; G05G 1/30

(52) U.S. Cl. 74/504

(57) ABSTRACT

The present disclosure relates to a traveling control system for a forklift, and more particularly, to a traveling control system for a forklift that is additionally equipped with a forward/backward lever in a forklift equipped with a mono-pedal and improves operational convenience and work efficiency by selecting the mono-pedal and the forward/backward lever in accordance with the operational environment, and makes it possible to rapidly and conveniently perform inching of the forklift, by improving the structure of the mono-pedal to be rapidly operated without unnecessary operations.

### CROSS-REFERENCE TO RELATED APPLICATIONS

This application is a Section 371 National Stage Application of International Application No. PCT/KR2009/006069, filed Oct. 21, 2009 and published, not in English, as WO2010/047517 on Apr. 29, 2010.

### FIELD OF THE DISCLOSURE

The present disclosure relates to a traveling control system for a forklift, particularly a traveling control system for a forklift which controls forward movement, backward movement, and acceleration of a forklift.

### BACKGROUND OF THE DISCLOSURE

In general, forklifts are widely used throughout the industry as a carrying means, which lifts or unloads weights and carries freight in a limited space, and equipped with a working device including a driving device that steers and drives the vehicle and a lift cylinder and a tilt cylinder that operate a mast assembly.

The driving apparatus or the working device is operated by hydraulic pressure generated by a hydraulic pump, the driving device is controlled by a brake pedal or an acceleration pedal, and the working device is controlled by a control lever.

A common type of driving devices of forklifts includes a forward/backward lever having forward, backward, and neutral functions and an acceleration pedal, and drives the forklift by operating the forward/backward lever and the acceleration pedal.

Further, a mono-pedal type of traveling control system for a forklift has been developed, which uses a mono-pedal having an integrated forward/backward selection and acceleration function, without the forward/backward lever and the acceleration pedal, and the mono-pedal is also called a mono-ped.

The mono-pedal type of control system selectively drives forward and backward and accelerates the vehicle by using a forward switch and a backward switch mounted on the acceleration pedal, without using the forward/backward lever, when driving the vehicle forward or backward.

The common type and mono-pedal type of traveling control systems for a forklift is selectively used in accordance with the type of work that the forklift usually performs or the driver's preference, such that it is impossible to switch the types, when the work environment or the driver changes.

On the other hand, the mono-pedal type of control system is equipped with an expensive autoshift controller, because it is not equipped with a forward/backward lever and a specific device for shifting.

Further, the operation of the mono-pedal that performs a forward/backward selection function and an acceleration function in the mono-pedal type of control system is composed of two steps of first determining whether to drive the vehicle forward or backward, by pressing a forward switch or a backward switch in the pedal, when the pedal is pressed down, and of secondly generating an acceleration signal when the pedal is further pressed down, in which selection of the forward or backward movement and generation of the acceleration are sequentially implemented.

Therefore, the forward switch or the backward switch is pressed and selects the direction and then the acceleration signal is generated every time the driver gets off and presses down the mono-pedal, such that the forward switch or the backward switch is unnecessarily operated and delay occurs in generating the acceleration signal, when the vehicle is continuously driven in one direction.

Further, it is required to increase the output of a hydraulic pump in order to compensate for insufficient power when operating the working device in the forklift and the increase in output of the hydraulic pump is achieved by increasing the number of revolution of an engine or an electric motor. Accordingly, it is necessary to press down the acceleration pedal in order to increase the output of the hydraulic pressure and it is required to operate the brake in order to prevent the vehicle from being rapidly driven by the increased output of the pump.

Therefore, although it is required to press down the brake pedal when pressing down the acceleration pedal to increase the output of the hydraulic pump, this is the main reason overloading the driving device. Further, it is difficult to restrict movement of the vehicle, when the pump output is higher than the braking force of the brake. Accordingly, an inching system that can rapidly cut the power for the driving device is used.

The inching system includes an inching pedal mounted at a side of the brake pedal, in which as the inching pedal is pressed down, pressurized oil supplied from an inching spool to a propelling shaft is stopped and braking is performed, such that the movement of the vehicle is restricted, and as the acceleration pedal is pressed down, with the inching pedal pressed down, the pump output is supplied only to the working device, such that sufficient hydraulic pressure for the working device can be acquired, which is called inching.

Since inching is implemented by operating a lift lever with the inching pedal pressed down, the leg of the driver gets tired and has to use both the hand and foot, such that it is difficult to quickly switch to inching.

The discussion above is merely provided for general background information and is not intended to be used as an aid in determining the scope of the claimed subject matter.

### SUMMARY

The present disclosure has been made in an effort to provide a traveling control system for a forklift that is equipped with a forward/backward lever and a mono-pedal and increase work convenience and working efficiency by making it possible to select any one of the forward lever and the mono-pedal to control the forklift in accordance with the driver or the working environment.

Further, the present disclosure has been made in an effort to provide a traveling control device for a forklift that improves response of the mono-pedal by reducing unnecessary operation of forward/backward switches and quickly generating an acceleration signal, when using the mono-pedal, and makes it possible to simply and quickly perform inching without operating an inching pedal, when operating a working device of the forklift.

The technical problems are not limited to the foregoing technical problems. Other technical problems, which are not described, can clearly be understood by those skilled in the art from the following description.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An exemplary embodiment of the present disclosure provides a traveling control system for a forklift, the system including: a forward/backward lever unit that generates a first shift signal that includes a first forward signal, a first backward signal, or a first neutral signal; a mono-pedal that generates a second shift signal that includes a second forward signal, a second backward signal, a second neutral signal, or an acceleration signal; a signal controller that controls the mono-pedal to restrict the second forward signal, the second backward signal, or the second neutral signal and activates the acceleration signal when the forward/backward lever generates the first forward signal or the first backward signal, and controls the mono-pedal to activate the second forward signal, the second backward signal, the neutral signal, or the acceleration signal when the forward/backward lever generates the first neutral signal; and a direction switch controller that switches the forward/backward movement direction of the forklift in response to the first and second shift signals generated from the forward/backward lever or the mono-pedal.

The mono-pedal may include: a mono-pedal box; a mono-pedal panel disposed on the top of the mono-pedal box and inclining left and right from a mono-pedal panel shaft; forward/backward switches disposed in the mono-pedal box and closed by the mono-pedal panel; and magnets disposed under the mono-pedal box and keeping the forward switch and the backward switch closed by applying magnetic force to the mono-pedal panel.

The traveling control system may further include a temporary neutral switch in a lift lever of the forklift, in which the temporary neutral switch may perform inching.

The traveling control system may further include a neutral switch in a driver seat operating unit of the forklift, in which the neutral switch may perform inching.

According to the exemplary embodiments of the present disclosure, since a forklift is equipped with both a forward/backward lever and a mono pedal and can selectively use them in accordance with the operational environment, such that it is possible to provide convenience for the driver and improve work efficiency.

Further, it is possible to save cost by removing an automatic transmission, because shifting can be performed by operating the forward/backward lever by hand.

Furthermore, since the magnets are attached to the mono-pedal, unnecessary repeated operation of the forward switch or the backward switch is prevented and the acceleration signal is generated, such that it is possible to improve response of the control system.

In addition, it is possible to rapidly perform inching, even without using an inching pedal in inching of the forklift, by further providing a specific neutral switch.

### DESCRIPTION OF THE DRAWINGS

FIG. 1 is an exemplary view illustrating a traveling control system for a forklift according to an exemplary embodiment of the present disclosure.

FIG. 2 is an exemplary view showing the structure of a mono-pedal in a traveling control system for a forklift according to another exemplary embodiment of the present disclosure.

FIG. 3 is an exemplary view showing the operation of a mono-pedal in a traveling control system for a forklift according to another exemplary embodiment of the present disclosure.

FIG. 4 is an exemplary view showing an example of a shift lever in a traveling control system for a forklift according to yet another exemplary embodiment of the present disclosure.

FIG. 5 is an exemplary view showing an example of a driver seat operating unit in a traveling control system for a forklift according to yet another exemplary embodiment of the present disclosure.

FIG. 6 is a flowchart illustrating the operation of a traveling control system for a forklift according to an exemplary embodiment of the present disclosure.

### DETAILED DESCRIPTION

The structure of the present disclosure is described hereafter in detail with reference to the accompanying drawings.

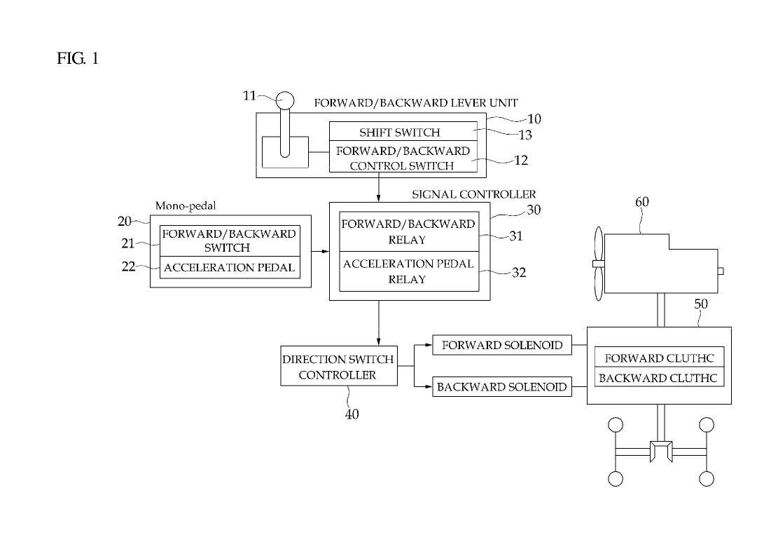

FIG. 1 is a block diagram illustrating the configuration of a traveling control system for a forklift according to an exemplary embodiment of the present disclosure.

The common type of control system equipped with a forward/backward lever, which is described above, is advantageous for work of moving in a predetermined direction, while the mono-pedal type of control system is advantageous for repetitive work with the direction frequently changing in a small space and does not operate the forward/backward lever, such that the driver is relatively free with both hands and conveniently works.

Further, it is required to implement both the forward/backward lever and the mono-pedal, because the forklift equipped with the forward/backward lever type of control system may also be used in an environment requiring the advantages of the mono-pedal type of control system or the opposite case may happen.

Therefore, a traveling control system according to the exemplary embodiment of the present disclosure is equipped with both a forward/backward lever unit 10 and a mono-pedal 20 and includes a signal controller 30 that determines priority of shift signals generated from forward/backward lever unit 10 and mono-pedal 20 and then transmits the signals to a forward/backward switching direction switch controller 40.

Forward/backward lever unit 10 may include a forward/backward lever 11 that shifts to a forward, backward, or neutral position and a forward/backward control switch 12 that generates a first shift signal that includes a first forward signal, a first backward signal, or a first neutral signal in accordance with the position of the forward/backward lever.

Mono-pedal 20 may include a forward/backward switch 21 that generates a second shift signal that includes a second forward signal, a second backward signal, or a second neutral signal in accordance with the user's operation, and an acceleration pedal 22 that generates an acceleration signal.

Signal controller 30 includes a forward/backward relay 31 and an acceleration pedal relay 32, and determines priority of the first shift signal generated from forward/backward lever unit 10 and the second shift signal generated from mono-pedal 20 and then transmits the shift signals to forward/backward switching direction switch controller 40.

Forward/backward switching direction switch controller 40 controls a transmission 50 connected with an engine 60 to move the vehicle by operating or stopping a forward solenoid that operates a forward clutch and a backward solenoid that operates a backward clutch, on the basis of the shift signals transmitted from signal controller 30.

Further, forward/backward lever unit 10 further includes a shift switch 13 that shifts the gears in the transmission of the forklift and may further include a manual shift function that generates shift control signals for shifting the gears of a transmission 60 into first to third gears.

In detail, a manual shift device including shift switch 13 is provided and may be implemented in various types, such as a rotary type of lever or a switch, which is an accessory of forward/backward lever 11.

Therefore, the driver can shift by hand, using the manual shift device attached to forward/backward lever 11, such that it is possible to shift, even without using an expensive automatic transmission that is used for traveling control systems for mono-pedal types of forklifts in the related art.

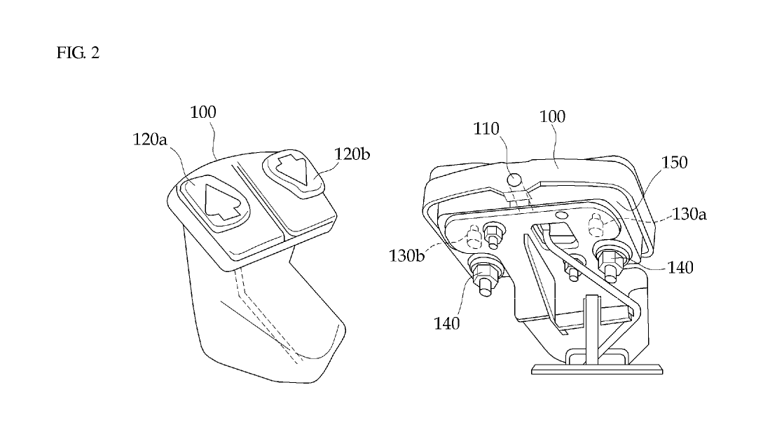

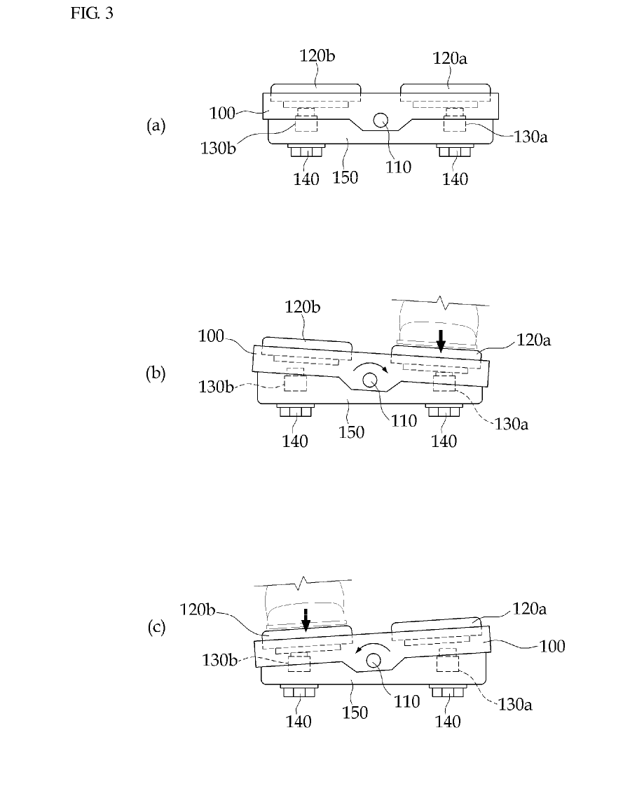

FIGS. 2 and 3 are views showing the structure of a mono-pedal equipped with a magnet 140 in a traveling control system for a forklift according to another exemplary embodiment of the present disclosure.

The mono-pedal, as shown in FIG. 2, may have a structure composed of a mono-pedal box 150, a mono-pedal panel 100 disposed on the top of mono-pedal box 150 and inclining left and right from a mono-pedal panel shaft 110, and forward/backward switches 130a and 130b disposed in mono-pedal box 150 and closed by mono-pedal panel 100, in which when the driver presses down a forward panel 120a or a backward panel 120b, a forward/backward movement is selected and an acceleration signal is generated.

In detail, as shown in FIG. 3, when forward panel 120a or backward panel 120b is pressed down, mono-pedal panel 100 presses forward switch 130a or backward switch 130b while inclining to the pressed panel from mono-pedal panel shaft 110, in which when the mono-pedal is further pressed down, an acceleration signal is generated.

In a mono-pedal according to another exemplary embodiment of the present disclosure, magnets 140 are disposed in mono-pedal box 150 under forward panel 120a and backward panel 120b of mono-pedal panel 100, such that when forward panel 120a or backward panel 120b is pressed down and mono-pedal 100 inclines, magnet 140 and mono-pedal 100 stick to each other by magnetic force of magnet 140 and mono-pedal 100 keeps pressing forward switch 130a or backward switch 130b in mono-pedal box 150 ((b) or (c) of FIG. 3).

Therefore, since forward switch 130a or backward switch 130b keeps pressed by mono-pedal panel 100, even if the driver completely takes the foot off mono-pedal panel 100, when mono-pedal 100 is pressed down again in the same direction, an acceleration signal is generated without operating forward switch 130a or backward switch 130b, such that it is possible to achieve rapid response when operating the mono-pedal.

Magnets 140 attached to the mono-pedal are usually permanent magnets, but they may be solenoids and are not limited thereto, and may be replaced by other members as long as they allow mono-pedal panel 100 to keep pressing the forward/backward switches.

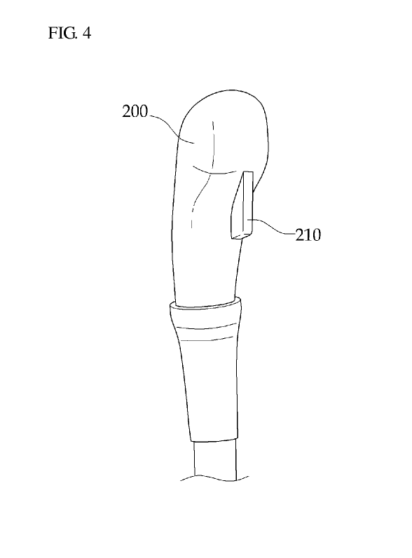

FIG. 4 is a perspective view of a lift lever 200 equipped with a temporary neutral switch 210 in a traveling control system for a forklift according to yet another exemplary embodiment of the present disclosure.

The neutral switch functions as an inching pedal and lift lever 200 operating a lift cylinder is equipped with temporary neutral switch 210 in the exemplary embodiment.

Inching is particularly needed for a lift work that lifting weights that applies large load to the forklift and the inching and accompanied by operation of the lift lever and the inching pedal for controlling a lift cylinder in lifting.

Since temporary neutral switch 210 functions as the inching pedal, when temporary neutral switch 210 attached to lift lever 200 is pressed, the pump output is supplied only to a working device, the engine power is increased, and the hydraulic pressure is increased, even if the inching pedal is not pressed and the acceleration pedal is pressed down, such that inching can be rapidly and simply performed.

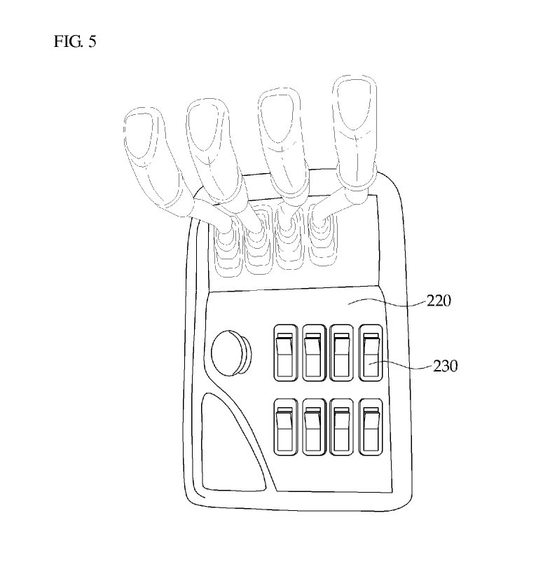

FIG. 5 is a perspective view showing a driver seat operating unit 220 equipped with a neutral switch 230 in a traveling control system for a forklift according to yet another exemplary embodiment of the present disclosure.

Neutral switch 230 may be provided at operating unit 220 of the driver's seat and it is possible to implement inching by using neutral switch 230 of the operating unit, without pressing down the inching pedal, even if a control lever that operates working devices other than lift lever 200 is used.

The operation of a traveling control system for a forklift according to an exemplary embodiment of the present disclosure is described hereafter through separate steps.

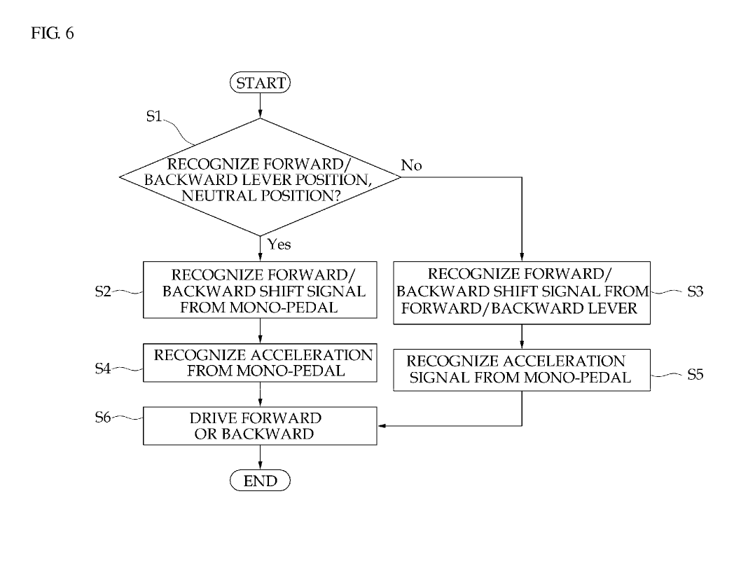

FIG. 6 is a flowchart illustrating the operation of a traveling control system for a forklift according to an exemplary embodiment of the present disclosure.

A traveling control system for a forklift according to the exemplary embodiment of the present disclosure may include a forward/backward lever unit 10 that is a part generating a first shift signal and a mono-pedal 20 that is a part generating a second shift signal, and a signal controller 30 that controls the first shift signal and the second shift signal that are generated from forward/backward lever unit 10 and mono-pedal 20.

Signal controller 30 restricts a second forward signal, a second backward signal, or a second neutral signal of the second shift signal of mono-pedal 20 and activates an acceleration signal, when the first shift signal is a first forward signal or a first backward signal.

Further, signal controller 30 activates the second forward signal, the second backward signal, the second neutral signal, or the acceleration signal of mono-pedal 20, when the first shift signal is a first neutral signal.

Referring to the flowchart shown in FIG. 6, the vehicle is driven by recognizing first whether forward/backward lever 11 is at the neutral position (S1), determining whether to move the vehicle forward or backward in accordance with forward/backward shift signals generated by mono-pedal 20 when forward/backward lever 11 is at the neutral position (S2), recognizing an acceleration signal generated from mono-pedal 20 (S4), and moving the vehicle forward or backward (S6).

If forward/backward lever 11 is at the forward or backward position, whether to move the vehicle forward or backward is determined by the forward/backward signals generated from forward/backward lever unit 10 (S3), only the acceleration signal is accepted while the forward/backward shift signals from mono-pedal 20 are disregarded (S5), and the vehicle is moved forward or backward (S6).

That is, the forward/backward signal transmitted to forward/backward switching direction switch controller 40 is determined by the shift signal generated from forward/backward lever unit 10 or mono-pedal 20, but the forward/backward signal generated from forward/backward lever unit 10 is always applied in priority to the forward/backward shift signal generated from mono-pedal 20.

Therefore, the driver can control the vehicle forward or backward, using forward/backward lever 11 or mono-pedal 20 of the traveling control system for a forklift according to the exemplary embodiment of the present disclosure, and moves forward/backward lever 11 to the forward or backward position such that a shift signal is generated and presses down mono-pedal 20 such that an acceleration signal is generated, in order to select whether to move forward or backward with forward/backward lever 11, such that the driver can drive the vehicle forward or backward.

Further, the driver presses down forward panel 110 or backward panel 120 of mono-pedal panel 100 with a foot such that forward/backward switch 21 in the mono pedal is pressed and a shift signal is generated, with forward/backward lever 11 at the neutral position, and then further presses down the mono-pedal such that an acceleration signal is generated, in order to select whether to move forward or backward with mono-pedal 20 and drive the vehicle, such that the driver can drive the vehicle forward or backward.

Therefore, the driver has only to move forward/backward lever 11 to the forward or backward position, when driving after determining whether to drive the vehicle forward or backward, but the driver has to drive the vehicle with mono-pedal 20, with forward/backward lever 11 at the neutral position, in order to drive after determining whether to move forward or backward as well as to accelerate the vehicle with mono-pedal 20.

A traveling control system for a forklift according to an exemplary embodiment of the present disclosure includes: a forward/backward lever unit that generates a first shift signal that includes a first forward signal, a first backward signal, or a first neutral signal; a mono-pedal that generates a second shift signal that includes a second forward signal, a second backward signal, a second neutral signal, or an acceleration signal; a signal controller that controls the mono-pedal to restrict the second forward signal, the second backward signal, or the second neutral signal and activates the acceleration signal when the forward/backward lever generates the first forward signal or the first backward signal, and controls the mono-pedal to activate the second forward signal, the second backward signal, the neutral signal, or the acceleration signal when the forward/backward lever generates the first neutral signal; and a direction switch controller that switches the forward/backward movement direction of the forklift in response to the first and second shift signals generated from the forward/backward lever or the mono-pedal.

The present disclosure described above is not limited to the exemplary embodiments and the accompanying drawings, and simple substitution, modification, and change within the spirit of the present disclosure are apparent to those skilled in the art.

Therefore, the exemplary embodiments described above should be construed as being exemplified and not limiting the present disclosure, and all changes and modifications from the meaning, range, and equivalent concept of the claims should be construed as being included in the present disclosure.

The present disclosure may be applied to industrial vehicles, such as a forklift.

1. A traveling control system for a forklift, the system comprising:
a forward/backward lever unit that generates a first shift signal that includes a first forward signal, a first backward signal, or a first neutral signal;
a mono-pedal that generates a second shift signal that includes a second forward signal, a second backward signal, a second neutral signal, or an acceleration signal;
a signal controller that controls the mono-pedal to restrict the second forward signal, the second backward signal, or the second neutral signal and activate the acceleration signal when the forward/backward lever generates the first forward signal or the first backward signal, and controls the mono-pedal to activate the second forward signal, the second backward signal, the neutral signal, or the acceleration signal when the forward/backward lever generates the first neutral signal; and
a direction switch controller that switches the forward/backward movement direction of the forklift in response to the first and second shift signals generated from the forward/backward lever 10 or the mono-pedal.

2. The traveling control system for a forklift of claim 1, wherein the mono-pedal includes: a mono-pedal box; a mono-pedal panel disposed on the top of the mono-pedal box and inclining left and right from a mono-pedal panel shaft; forward/backward switches disposed in the mono-pedal box and closed by the mono-pedal panel; and magnets disposed under the mono-pedal box and keeping the forward switch and the backward switch closed by applying magnetic force to the mono-pedal panel.

3. The traveling control system for a forklift of claim 1 further comprising a temporary neutral switch in a lift lever of the forklift, wherein the temporary neutral switch performs inching.

4. The traveling control system for a forklift of claim 3, further comprising a neutral switch in a driver seat operating unit of the forklift, wherein the neutral switch performs inching.

5. The traveling control system for a forklift of claim 2, further comprising a temporary neutral switch in a lift lever of the forklift, wherein the temporary neutral switch performs inching.

6. The traveling control system for a forklift of claim 5, further comprising a neutral switch in a driver seat operating unit of the forklift, wherein the neutral switch performs inching.
